(19) United States
(12) Patent Application Publication
(10) Pub. No.: US 2026/0106158 A1
(43) Pub. Date: Apr. 16, 2026

(54) ALL-SOLID-STATE BATTERY

(71) Applicant: SAMSUNG SDI CO., LTD., Yongin-si (KR)

(72) Inventors: Jinhoon YANG, Yongin-si (KR); Juhee SOHN, Yongin-si (KR); Haena YIM, Yongin-si (KR); Hyuksoo SHIN, Yongin-si (KR); Seungman PARK, Yongin-si (KR); Haejoo KIM, Yongin-si (KR)

(21) Appl. No.: 19/349,150

(22) Filed: Oct. 3, 2025

(30) Foreign Application Priority Data
Oct. 11, 2024 (KR) 10-2024-0138612

(51) Int. Cl. H01M 4/62; H01M 4/02; H01M 10/0525

(52) U.S. Cl. CPC H01M 4/625; H01M 4/626; H01M 10/0525; H01M 2004/021; H01M 2004/027; H01M 2004/028

(57) ABSTRACT

Disclosed are negative electrodes and all-solid-state batteries. The negative electrode includes a negative electrode current collector, a first negative electrode coating layer on the negative electrode current collector and including a first metal and a first carbon, and a second negative electrode coating layer on the first negative electrode coating layer and including a second metal and a second carbon. ΔG1 is given as Gibbs free energy of a chemical reaction at 250° C. between the first metal and molten lithium. ΔG2 is given as Gibbs free energy of a chemical reaction at 250° C. between the second metal and molten lithium. ΔG1 and ΔG2 satisfies the relationship of ΔG1<ΔG2. A ratio of a thickness of the second negative electrode coating layer to a thickness of the first negative electrode coating layer is about 0.6 to about 1.4.

### CROSS-REFERENCE TO RELATED APPLICATION

The present application claims priority to and the benefit of Korean Patent Application No. 10-2024-0138612, filed on Oct. 11, 2024, in the Korean Intellectual Property Office, the entire content of which is hereby incorporated by reference.

### BACKGROUND

Embodiments of the present disclosure relate to an all-solid-state battery, and for example, to an all-solid-state battery including a lithium deposition buffer layer.

There has recently been active development of high-energy density and safe batteries driven by industrial demands. For example, lithium ion batteries are being commercialized not only in formation-related and communication devices but also in the automotive industry. In the automotive industry, safety is particularly emphasized due to its direct relation to human lives.

There has recently been suggested an all-solid-state battery that uses a solid electrolyte in place of a liquid electrolyte. As an all-solid-state battery does not use a flammable organic dispersion medium, the possibility of fire or explosion may be significantly reduced even in the event of short-circuit. Accordingly, an all-solid-state battery may significantly increase safety as compared to a lithium ion battery using a liquid electrolyte.

### SUMMARY

An embodiment of the present disclosure provides an all-solid-state battery having extended lifespan.

According to an embodiment of the present disclosure, a negative electrode for an all-solid-state battery may include: a negative electrode current collector; a first negative electrode coating layer on the negative electrode current collector, wherein the first negative electrode coating layer includes a first metal and a first carbon; and a second negative electrode coating layer on the first negative electrode coating layer, wherein the second negative electrode coating layer includes a second metal and a second carbon. ΔG1 may be given as Gibbs free energy of a chemical reaction at 250° C. between the first metal and molten lithium. ΔG2 may be given as Gibbs free energy of a chemical reaction at 250° C. between the second metal and molten lithium. ΔG1 and ΔG2 may satisfy the relationship of ΔG1<ΔG2. A ratio of a thickness of the second negative electrode coating layer to a thickness of the first negative electrode coating layer may be in a range of about 0.6 to about 1.4.

According to an embodiment of the present disclosure, an all-solid-state battery may include: a positive electrode layer; a negative electrode layer; and a solid electrolyte layer between the positive electrode layer and the negative electrode layer. The negative electrode layer may include: a negative electrode current collector; a first negative electrode coating layer on the negative electrode current collector, wherein the first negative electrode coating layer includes a first metal and a first carbon; and a second negative electrode coating layer on the first negative electrode coating layer, wherein the second negative electrode coating layer includes a second metal and a second carbon. An ionic conductivity of the first negative electrode coating layer may be greater than an ionic conductivity of the second negative electrode coating layer. An electrical conductivity of the second negative electrode coating layer may be greater than an electrical conductivity of the first negative electrode coating layer. A sum of a thickness of the first negative electrode coating layer and a thickness of the second negative electrode coating layer may be in a range of about 5 μm to about 15 μm.

According to an embodiment of the present disclosure, an all-solid-state battery may include: a positive electrode layer; a negative electrode layer; and a solid electrolyte layer between the positive electrode layer and the negative electrode layer. The negative electrode layer may include: a negative electrode current collector; a first negative electrode coating layer on the negative electrode current collector, wherein the first negative electrode coating layer includes a first metal and a first carbon; and a second negative electrode coating layer on the first negative electrode coating layer, wherein the second negative electrode coating layer includes a second metal and a second carbon. ΔG1 may be given as Gibbs free energy of a chemical reaction at 250° C. between the first metal and molten lithium. ΔG2 may be given as Gibbs free energy of a chemical reaction at 250° C. between the second metal and molten lithium. ΔG1 and ΔG2 may satisfy the relationship of ΔG1<ΔG2. A ratio of a thickness of the second negative electrode coating layer to a thickness of the first negative electrode coating layer may be in a range of about 0.6 to about 1.4.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a plan view showing an all-solid-state battery according to an embodiment of the present disclosure.

FIG. 2 is a cross-sectional view showing an all-solid-state battery according to an embodiment of the present disclosure.

FIG. 3 is a cross-sectional view showing an all-solid-state battery according to an embodiment of the present disclosure.

FIG. 4 is a cross-sectional view showing a negative electrode for an all-solid-state battery according to an embodiment of the present disclosure.

FIGS. 5A and 5B are graphs showing electrical conductivity and ionic conductivity as a function of distance depicted in FIG. 4.

FIG. 6 is a cross-sectional view showing a negative electrode for an all-solid-state battery according to an embodiment of the present disclosure.

### DETAILED DESCRIPTION

In order to sufficiently understand the configuration and effect of the subject matter of the present disclosure, some embodiments of the present disclosure will be described with reference to the accompanying drawings. It should be noted, however, that the subject matter of the present disclosure is not limited to the following example embodiments, and may be implemented in various suitable forms. Rather, the example embodiments are provided only to disclose embodiments of the present disclosure and let those skilled in the art fully know the scope of the present disclosure.

In this description, it will be understood that, if (e.g., when) an element is referred to as being on another element, the element can be directly on the other element or intervening elements may be present between therebetween. In the drawings, thicknesses of some components may be exaggerated to effectively explain the technical contents. Like reference numerals refer to like elements throughout the specification.

Some embodiments detailed in this description will be discussed with reference to sectional and/or plan views as idealized or schematic example views of the present disclosure. In the drawings, thicknesses of layers and regions may be exaggerated to effectively explain the technical contents. Accordingly, regions illustrated as examples in the drawings have general properties, and shapes of regions illustrated as examples in the drawings are used to disclose examples of set or specific shapes but not limited to the scope of the present disclosure. It will be understood that, although the terms “first”, “second”, “third”, and/or the like may be used herein to describe various elements, these elements should not be limited by these terms.

These terms are only used to distinguish one element from another element. The example embodiments explained and illustrated herein include complementary embodiments thereof.

Unless otherwise specially noted in this description, the expression of singular form may include the expression of plural form. In embodiments, unless otherwise specially noted, the phrase “A or B” may indicate “A but not B”, “B but not A”, and “A and B”. The terms “comprises/includes” and/or “comprising/including” used in this description do not exclude the presence or addition of one or more other components.

In this description, the term “combination thereof” may refer to a mixture, a stack, a composite, a copolymer, an alloy, a blend, or a reaction product.

Unless otherwise especially defined in this description, a particle diameter may be an average particle diameter. In embodiments, a particle diameter indicates an average particle diameter (D₅₀) of particles having a cumulative volume of 50 vol % in a particle size distribution. The average particle diameter (D₅₀) may be measured by any suitable method generally used in the art, for example, by a particle size analyzer, a transmission electron microscope (TEM) image, and/or a scanning electron microscope (SEM) image. In embodiments, a dynamic light-scattering measurement device may be used to perform a data analysis, the number of particles is counted for each particle size range, and then from this, an average particle diameter (D₅₀) value may be obtained through a calculation. Dissimilarly, a laser scattering method may be utilized to measure the average particle diameter (D₅₀). In the laser scattering method, a target particle is dispersed in a dispersion solvent, introduced into a laser scattering particle measurement device (e.g., MT3000 commercially available from Microtrac, Inc.), irradiated with ultrasonic waves of 28 kHz at a power of 60 W, and then an average particle diameter (D₅₀) is calculated in the 50% standard of the particle diameter distribution in the measurement device.

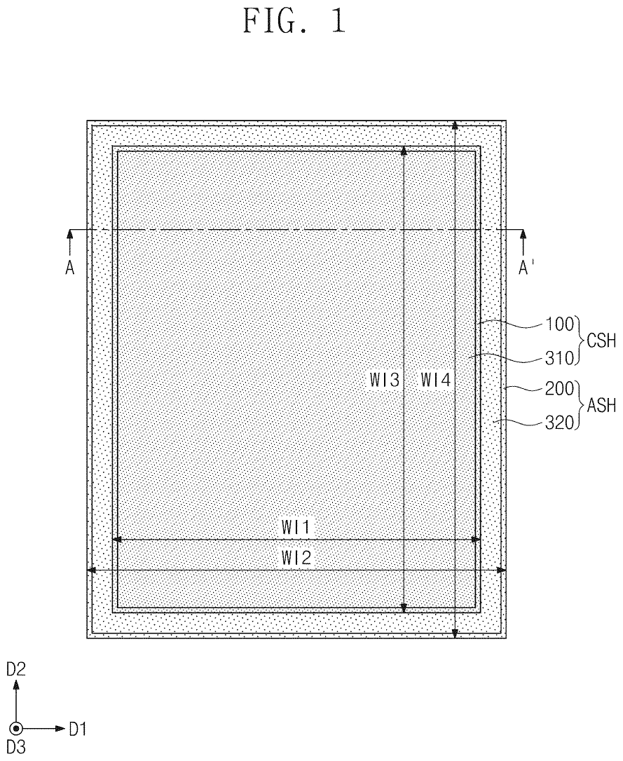

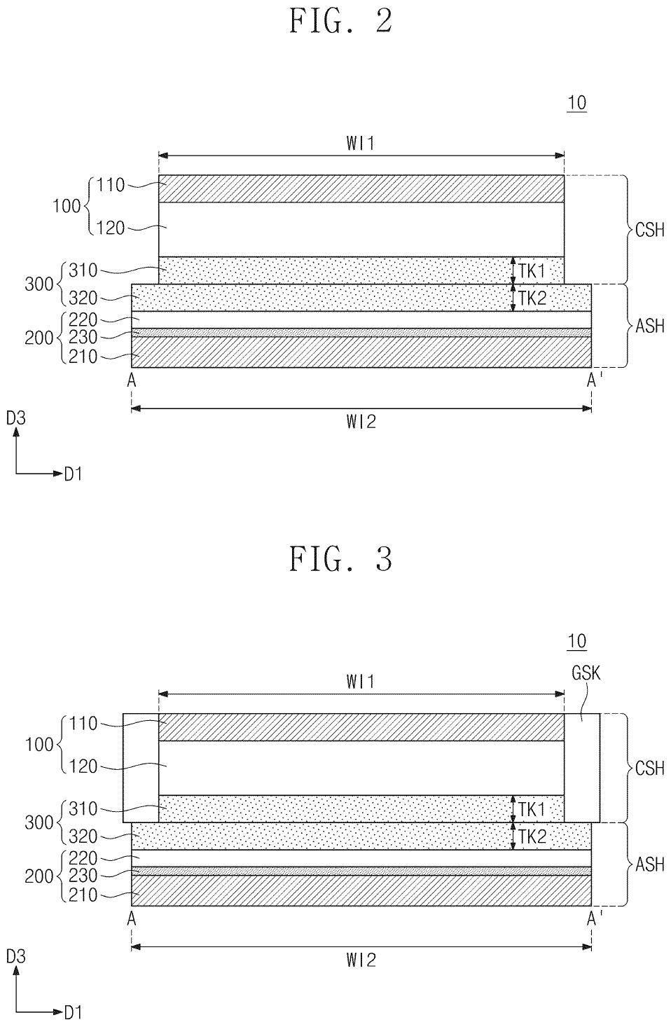

FIG. 1 is a plan view showing an all-solid-state battery according to an embodiment of the present disclosure. FIG. 2 is a cross-sectional view taken along line A-A′ of FIG. 1.

Referring to FIGS. 1 and 2, an all-solid-state battery 10 according to embodiments of the present disclosure may include a positive electrode layer 100, a negative electrode layer 200 opposite to the positive electrode layer 100, and a solid electrolyte layer 300 between the positive electrode layer 100 and the negative electrode layer 200. The present disclosure, however, is not limited thereto, and the all-solid-state battery 10 may further include an additional functional layer, such as an adhesion enhancement layer, between the positive electrode layer 100 and the solid electrolyte layer 300 and/or between the negative electrode layer 200 and the solid electrolyte layer 300.

The positive electrode layer 100 according to an embodiment of the present disclosure may include a positive electrode current collector 110 and a positive electrode active material layer 120 on the positive electrode current collector 110. The positive electrode active material layer 120 may include a positive electrode active material, a solid electrolyte, a conductive material (e.g., an electrically conductive material), and a binder.

The positive electrode current collector 110 may provide a reference surface on which the positive electrode active material layer 120 is provided. The positive electrode current collector 110 may include a plate and/or foil including, for example, indium (In), copper (Cu), magnesium (Mg), stainless steel, titanium (Ti), iron (Fe), cobalt (Co), nickel (Ni), zinc (Zn), aluminum (AI), germanium (Ge), lithium (Li), and/or an alloy thereof.

Differently from that shown in FIG. 2, in an embodiment of the present disclosure, the positive electrode current collector 110 may not be provided. In embodiments, in order to increase adhesion between the positive electrode current collector 110 and the positive electrode active material layer 120, a carbon layer having a thickness of about 0.1 μm to about 4 μm may further be between the positive electrode current collector 110 and the positive electrode active material layer 120.

The positive electrode active material of the positive electrode active material layer 120 may include a material that can reversibly absorb and desorb lithium ions. The positive electrode active material may include a plurality of particles. For example, the positive electrode active material may include lithium transition metal oxide (e.g., lithium cobalt oxide (LCO), lithium nickel oxide, lithium nickel cobalt oxide, lithium nickel cobalt aluminum oxide (NCA), lithium nickel cobalt manganese oxide (NCM), lithium manganate, and/or lithium iron phosphate), nickel sulfide, copper sulfide, lithium sulfide, iron oxide, and/or vanadium oxide, but the present disclosure is not limited thereto. The positive electrode active material may be used alone or in a mixture of two or more substances.

The lithium transition metal oxide may be, for example, a compound represented by one of LiₐA_{1-b}B_{b}D₂ (where 0.90≤a≤1 and 0≤b≤0.5), LiₐE_{1-b}B_{b}O_{2-c}D_{c} (where 0.90≤a≤1, 0≤b≤0.5, and 0≤c≤0.05), LiE_{2-b}B_{b}O_{4-c}D_{c} (where 0≤b≤0.5 and 0≤c≤0.05), LiₐNi_{1-b-c}Co_{b}B_{c}D_{α} (where 0.90≤a<1, 0<b>0.5, 0<c<0.05, and 0<α<2), LiₐNi_{1-b-c}Co_{b}B_{c}O_{2-α}F_{α} (where 0.90≤a≤1, 0≤b≤0.5, 0≤c≤0.05, and 0<α<2), LiₐNi_{1-b-c}Mn_{b}B_{c}D_{α} (where 0.90≤a≤1, 0≤b≤0.5, 0≤c≤0.05, and 0<a≤2), LiₐNi_{1-b-c}Mn_{b}B_{c}O_{2-α}F_{α} (where 0.90≤a≤1, 0≤b≤0.5, 0≤c≤0.05, and 0<α≤2), LiₐNi_{b}E_{c}G_{d}O₂ (where 0.90≤a≤1, 0≤b≤0.9, 0≤c≤0.5, and 0.001≤d≤0.1), LiₐNi_{b}Co_{c}Mn_{d}GₑO₂ (where 0.90≤a≤1, 0≤b≤0.9, 0≤c≤0.5, 0≤d≤0.5, and 0.001≤e≤0.1), LiₐNiG_{b}O₂ (where 0.9≤a≤1 and 0.001≤b≤0.1), LiₐCoG_{b}O₂ (where 0.90≤a≤1 and 0.001≤b≤0.1), LiₐMnG_{b}O₂ (where 0.90≤a≤1 and 0.001≤b≤0.1), LiₐMn₂G_{b}O₄ (where 0.90≤a≤1 and 0.001≤b≤0.1), QO₂, QS₂, LiQS₂, V₂O₅, LiV₂O₅, LiIO₂, LiNiVO₄, Li_{3-f}J₂(PO₄)₃ (where 0≤f≤2), Li_{3-f}Fe₂(PO₄)₃ (where 0≤f≤2), and LiFePO₄. In the compounds above, “A” may be Ni, Co, Mn, or a combination thereof, “B” may be Al, Ni, Co, Mn, Cr, Fe, Mg, Sr, V, a rare-earth element, or a combination thereof, “D” may be O, F, S, P, or a combination thereof, “E” may be Co, Mn, or a combination thereof, “F” may be F, S, P, or a combination thereof, “G” may be Al, Cr, Mn, Fe, Mg, La, Ce, Sr, V, or a combination thereof, “Q” may be Ti, Mo, Mn, or a combination thereof, “I” may be Cr, V, Fe, Sc, Y, or a combination thereof, and “J” may be V, Cr, Mn, Co, Ni, Cu, or a combination thereof.

The positive electrode active material may include, for example, lithium salt of transition metal oxide having a layered rock salt type structure among lithium transition metal oxides discussed above. The term “layered rock salt type structure” may refer to a structure in which an oxygen atom layer and a metal atom layer are alternately and regularly provided in a <111> direction of a cubic rock salt type structure (e.g., a cubic rock salt kind of structure), where each atom layer forms a two-dimensional plane. The term “cubic rock salt type structure” may refer to a sodium chloride (NaCl) type structure (e.g., a sodium chloride (NaCl) kind of structure), which is a type (or kind) of crystal structure, and for example, has a structure in which face centered cubic lattices (FCCs) each formed of cations and anions are provided displaced from each other by ½ of a ridge of a unit lattice. The lithium transition metal oxide having the layered rock salt type structure may be a ternary lithium transition metal oxide, such as LiNiₓCo_{y}Al_{z}O₂ (NCA) and/or LiNiₓCo_{y}Mn_{z}O₂ (NCM) (where 0<x<1, 0<y<1, 0<z<1, and x+y+z=1). If (e.g., when) the positive electrode active material includes a ternary lithium transition metal oxide having the layered rock salt type structure, the all-solid-state battery 10 may have increased energy density and improved thermal stability.

The compound included in the positive electrode active material may be covered by a coating layer. The positive electrode active material may be used in a mixture of the compound and a compound to which the coating layer is added. The coating layer added to a surface of the positive electrode active material may include, for example, oxide, hydroxide, oxyhydroxide, oxycarbonate, and/or hydrocarbonate of a coating element discussed below. The compound that constitutes the coating layer may be amorphous and/or crystalline. The coating element included in the coating layer may include Mg, Al, Co, K, Na, Ca, Si, Ti, V, Sn, Ge, Ga, B, As, Zr, or a mixture thereof. The coating layer may include, for example, Li₂O—ZrO₂ (LZO). A method for forming the coating layer may be selected within any suitable methods that do not adversely affect physical characteristics of the positive electrode active material. The method of forming the coating layer may include, for example, spray coating and/or immersion.

If (e.g., when) the positive electrode active material includes nickel (Ni) as a ternary lithium transition metal oxide such as NCA and/or NCM, a capacity density of the all-solid-state battery 10 may increase to reduce metal elution from the positive electrode active material in a charged state. Therefore, the all-solid-state battery 10 may improve in cycle characteristics in a charged state. The language “cycle characteristics” may refer to properties that indicate the degree to which the all-solid-state battery 10 is degraded due to charge and discharge. For example, the all-solid-state battery 10 having high cycle characteristics may degrade less due to charge and discharge, while the all-solid-state battery 10 having low cycle characteristics may degrade more due to charge and discharge.

The positive electrode active material may have, for example, a spherical (e.g., a generally spherical) or oval (e.g., a generally oval) particle shape. There is no limitation on a particle diameter and an amount of the positive electrode active material.

The solid electrolyte of the positive electrode active material layer 120 may have a particle shape. The solid electrolyte may be dispersed between the positive electrode active materials. The solid electrolyte may include a sulfide-based solid electrolyte having excellent lithium ionic conductivity. The sulfide-based solid electrolyte may include, for example, at least one selected from Li₂S—P₂S₅, Li₂S—P₂S₅—LiX (where X is a halogen element), Li₂S—P₂S₅—Li₂O, Li₂S—P₂S₅—Li₂O—LiI, Li₂S—SiS₂, Li₂S—SiS₂—LiI, Li₇S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each a positive integer, and “Z” is one selected from Ge, Zn, and Ga), Li₂S—GeS₂, Li₂S—SiS₂—Li₃PO₄, Li₂S—SiS₂—LiₚMO_{q} (where p and q are each a positive integer, and “M” is one selected from P, Si, Ge, B, Al, Ga, and In), Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2).

The sulfide-based solid electrolyte may be an argyrodite-type compound including, for example, at least one selected from Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). For example, the sulfide-based solid electrolyte may be an argyrodite-type compound including at least one selected from Li₆PS₅Cl, Li₆PS₅Br, and Li₆PS₅I.

In embodiments, the sulfide-based solid electrolyte may be an argyrodite-type compound including Li₇₋ₐMₐPS_{6-c}X_{c} (where 0≤a≤2 and 0≤c≤2). In the chemical formula above, X may be F, Br, Cl, or a combination thereof. M may be scandium (Sc), yttrium (Y), titanium (Ti), zirconium (Zr), hafnium (Hf), vanadium (V), niobium (Nb), tantalum (Ta), chromium (Cr), molybdenum (Mo), tungsten (W), manganese (Mn), technetium (Tc), rhenium (Re), iron (Fe), ruthenium (Ru), osmium (Os), cobalt (Co), rhodium (Rh), iridium (Ir), nickel (Ni), palladium (Pd), platinum (Pt), copper (Cu), silver (Ag), gold (Au), zinc (Zn), cadmium (Cd), mercury (Hg), aluminum (Al), gallium (Ga), indium (In), thallium (Tl), silicon (Si), germanium (Ge), tin (Sn), lead (Pb), arsenic (As), antimony (Sb), bismuth (Bi), or a combination thereof.

The argyrodite-type solid electrolyte may have a density of about 1.5 g/cc to about 2.0 g/cc. As the argyrodite-type solid electrolyte has a density of equal to or greater than about 1.5 g/cc, it may be possible to decrease an internal resistance (e.g., electrical resistance) of an all-solid-state battery and to prevent a solid electrolyte layer from short-circuit and penetration caused by the formation of lithium dendrites (or to reduce a likelihood, occurrence, or degree thereof). The solid electrolyte may have an elastic modulus of, for example, about 15 GPa to about 35 GPa.

The solid electrolyte in the positive electrode active material layer 120 may have an average particle diameter less than those of first and second electrolytes in the solid electrolyte layer 300 which will be further discussed below. For example, the average particle diameter of the solid electrolyte in the positive electrode active material layer 120 may be about equal to or less than about 90%, 80%, 70%, 60%, 50%, 40%, 30%, or 20% of the average particle diameter of a solid electrolyte included in the solid electrolyte layer 300. The average particle diameter may be a median diameter measured with a laser-type particle size distribution analyzer.

The positive electrode active material layer 120 may include a conductive material (e.g., an electrically conductive material). The conductive material may have conductivity without causing a chemical change (e.g., an undesirable chemical change) of the all-solid-state battery 10 to increase conductivity (e.g., electrical conductivity) of the positive electrode active material and the solid electrolyte. The conductive material may include a carbon-based material. The conductive material may include, for example, one or more selected from graphite, carbon black, acetylene black, carbon nano-fiber, and carbon nano-tube.

The positive electrode active material layer 120 may further include a binder. The binder may combine with each other the positive electrode active material, the solid electrolyte, and the conductive material in the positive electrode active material layer 120. The binder may include a material that improves adhesion between the positive electrode active material layer 120 and the positive electrode current collector 110. The binder may include, for example, polyvinylidenefluoride, styrene-butadiene rubber (SBR), polytetrafluoroethylene, vinylidenefluoride/hexafluoropropylene copolymer, polyacrylonitrile, and/or polymethyl methacrylate.

Based on the total 100 parts by weight of the positive electrode active material, the solid electrolyte, the conductive material, and the binder, the positive electrode active material may be included in an amount of about 85 parts by weight to about 92 parts by weight in the positive electrode active material layer 120. Based on the total 100 parts by weight of the positive electrode active material, the solid electrolyte, the conductive material, and the binder, the binder may be included in an amount of about 0.5 parts by weight to about 1.5 parts by weight in the positive electrode active material layer 120.

Based on 100 parts by weight of the solid electrolyte, the conductive material may be included in an amount of about 1 part by weight to about 50 parts by weight in the positive electrode active material layer 120. If (e.g., when) the conductive material is included in an amount of less than about 1 part by weight relative to 100 parts by weight of the solid electrolyte, a proportion of the conductive material may decrease to reduce an electrical conductivity of the positive electrode active material layer 120. If (e.g., when) the conductive material is included in an amount of greater than about 50 parts by weight relative to 100 parts by weight of the solid electrolyte, a proportion of the conductive material may excessively increase to cause incomplete formation of a coating layer that covers a surface of the solid electrolyte.

The positive electrode active material layer 120 may further include an additive, such as a filler, a coating agent, a dispersant, and/or an ionic conductivity agent, in addition to the positive electrode active material, the solid electrolyte, the conductive material, and the binder.

The negative electrode layer 200 may include a negative electrode current collector 210 and a negative electrode coating layer 220 on the negative electrode current collector 210.

The negative electrode current collector 210 may provide a reference surface on which the negative electrode coating layer 220 is provided. The negative electrode current collector 210 may include a material that does not react with lithium, for example, a material that does not form an alloy or a compound with lithium. For example, the negative electrode current collector 210 may include at least one metal selected from copper (Cu), stainless steel, titanium (Ti), iron (Fe), cobalt (Co), and nickel (Ni). A thickness of the negative electrode current collector 210 may be in a range from about 1 μm to about 20 μm, for example, from about 5 μm to about 15 μm or from about 7 μm to about 10 μm.

The negative electrode current collector 210 may be formed of one of the metals mentioned above, an alloy of two or more of the metals mentioned above, or a coating material. The negative electrode current collector 210 may have, for example, a plate or foil shape. In an embodiment, the negative electrode current collector 210 may not be provided.

In an embodiment, a carbon layer may further be included to increase adhesion between the negative electrode coating layer 220 and the solid electrolyte layer 300.

The solid electrolyte layer 300 may be provided between the positive electrode layer 100 and the negative electrode layer 200. The solid electrolyte layer 300 may include a sulfide-based solid electrolyte having excellent lithium ionic conductivity. The solid electrolyte included in the solid electrolyte layer 300 may include a material the same as or different from that of the solid electrolyte included in the positive electrode active material layer 120.

The solid electrolyte layer 300 may include a first solid electrolyte layer 310 and a second solid electrolyte layer 320. The first solid electrolyte layer 310 may be adjacent to the positive electrode layer 100, and the second solid electrolyte layer 320 may be adjacent to the negative electrode layer 200.

Referring to FIG. 2, the first solid electrolyte layer 310 may include a first solid electrolyte. The first solid electrolyte may have a spherical or oval (e.g., a generally spherical or generally oval) particle shape. The first solid electrolyte may include a sulfide-based solid electrolyte. The first solid electrolyte may be in an amorphous state, a crystalline state, or a mixed state of amorphous and crystalline states. The solid electrolyte may include at least sulfur(S), phosphorus (P), and lithium (Li) among component elements included in the sulfide-based solid electrolyte mentioned above. For example, the solid electrolyte may be a material including Li₂S—P₂S₅. If (e.g., when) Li₂S—P₂S₅ is utilized as the sulfide-based solid electrolyte material of the solid electrolyte, a mixing molar ratio of Li₂S and P₂S₅ may be in a range of about 50:50 to about 90:10.

For example, the first solid electrolyte may include an argyrodite-type compound including, for example, at least one selected from Li₇₋ₓPS₆₋ₓClₓ (where 0≤x≤2), Li₇₋ₓPS₆₋ₓBrₓ (where 0≤x≤2), and Li₇₋ₓPS₆₋ₓIₓ (where 0≤x≤2). The first solid electrolyte may include an argyrodite-type compound including at least one selected from Li₆PS₅Cl, Li₆PS₅Br, and Li₆PS₅I.

In embodiments, the first solid electrolyte may include an argyrodite-type compound including Li₇₋ₐMₐPS_{6-c}X_{c}. In the chemical formula above, X may be Cl, Br, or a combination thereof. M may be Na, K, Fe, Mg, Ca, Ag, Cu, Zr, Zn, or a combination thereof. The subscripts a and c may each be a real number between 0 and 2.

The argyrodite-type solid electrolyte may have a density of about 1.5 g/cc to about 2.0 g/cc. As the argyrodite-type solid electrolyte has a density of equal to or greater than about 1.5 g/cc, it may be possible to decrease an internal resistance (e.g., electrical resistance) of an all-solid-state battery and to prevent a solid electrolyte layer from short-circuit and penetration caused by the formation of lithium dendrites (or to reduce a likelihood, occurrence, or degree thereof). The first solid electrolyte may have a modulus of, for example, about 15 GPa to about 35 GPa.

The first solid electrolyte layer 310 may further include a binder. The binder included in the first solid electrolyte layer 310 may include, for example, styrene-butadiene rubber (SBR), polytetrafluoroethylene, polyvinylidenefluoride, and/or polyethylene, but the present disclosure is not limited thereto. The binder of the first solid electrolyte layer 310 may be the same as or different from that of the positive electrode active material layer 120 or that of the negative electrode coating layer 220.

The second solid electrolyte layer 320 may include a second solid electrolyte. The second solid electrolyte may have a spherical or oval (e.g., a generally spherical or generally oval) particle shape.

The second solid electrolyte may include a sulfide-based solid electrolyte. A description of the second solid electrolyte may be the same as or similar to that of the first solid electrolyte. In an embodiment, the second solid electrolyte may have substantially the same composition as that of the first solid electrolyte. In another embodiment, the second solid electrolyte may have a similar composition to that of the first solid electrolyte.

The second solid electrolyte may be in direct contact with the negative electrode coating layer 220. Thus, the second solid electrolyte may suppress or reduce formation of lithium dendrites between the negative electrode coating layer 220 and the negative electrode current collector 210. The second solid electrolyte may effectively suppress or reduce side reactions of the negative electrode. Therefore, the all-solid-state battery 10 according to the present disclosure may improve in cell performance.

The first solid electrolyte layer 310 may have a first thickness TK1, and the second solid electrolyte layer 320 may have a second thickness TK2. The first thickness TK1 and the second thickness TK2 may be the same as or different from each other. In an embodiment, the first thickness TK1 may be greater than the second thickness TK2. For example, the first thickness TK1 may be about 1.1 to 5 times the second thickness TK2.

Referring back to FIGS. 1 and 2, the positive electrode layer 100 and the first solid electrolyte layer 310 may constitute a positive electrode mixture layer CSH. The negative electrode layer 200 and the second solid electrolyte layer 320 may constitute a negative electrode mixture layer ASH. The positive electrode mixture layer CSH may be on the negative electrode mixture layer ASH.

The negative electrode mixture layer ASH and the positive electrode mixture layer CSH may have their areas different from each other. For example, the area of the negative electrode mixture layer ASH may be greater than that of the positive electrode mixture layer CSH. The positive electrode mixture layer CSH may completely inwardly overlap the negative electrode mixture layer ASH.

In an embodiment of the present disclosure, the first solid electrolyte layer 310 may have substantially the same area as that of the positive electrode layer 100. The second solid electrolyte layer 320 may have substantially the same area as that of the negative electrode layer 200.

For example, the positive electrode mixture layer CSH may have a first width WI1 in a first direction D1. The negative electrode mixture layer ASH may have a second width W12 in the first direction D1. The first width WI1 may be less than the second width W12. The positive electrode mixture layer CSH may have a third width W13 in a second direction D2. The negative electrode mixture layer ASH may have a fourth width WI4 in the second direction D2. The third width WI3 may be less than the fourth width WI4.

The all-solid-state battery 10 according to the present embodiment may be fabricated by forming the negative electrode mixture layer ASH on a first carrier film, forming the positive electrode mixture layer CSH on a second carrier film, and then laminating the negative electrode mixture layer ASH and the positive electrode mixture layer CSH.

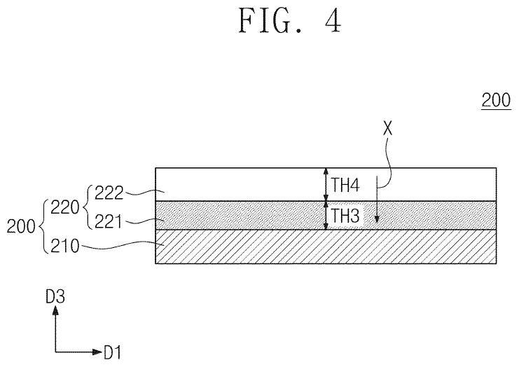

FIG. 3 is a cross-sectional view taken along line A-A′ of FIG. 1, showing an all-solid-state battery according to an embodiment of the present disclosure. In the embodiment that follows, a detailed description of technical features repetitive to those discussed above with reference to FIGS. 1 and 2 may not be repeated here, and a difference thereof will be discussed in more detail.

Referring to FIG. 3, the all-solid-state battery 10 may include a gasket GSK. The gasket GSK may be provided around (e.g., to surround) the positive electrode mixture layer CSH. A difference in area between the negative electrode mixture layer ASH and the positive electrode mixture layer CSH may produce a step difference on a lateral surface of the all-solid-state battery 10, and the gasket GSK may fill the step difference. The gasket GSK may be around (e.g., surround) four lateral surfaces of the positive electrode mixture layer CSH. For example, a thickness of the gasket GSK may be substantially the same as that of the positive electrode mixture layer CSH.

A top surface of the second solid electrolyte layer 320 may include a first region in contact with the first solid electrolyte layer 310 and a second region in contact with the gasket GSK. The second region may be a peripheral area of the top surface of the second solid electrolyte layer 320. The second region may surround the first region.

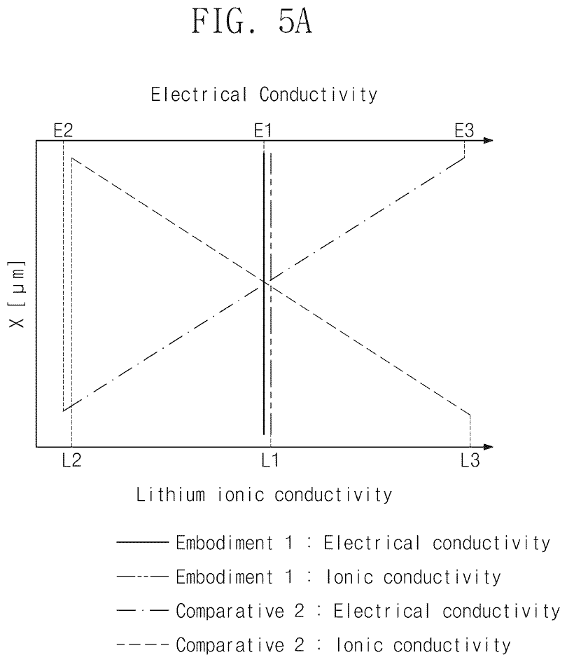

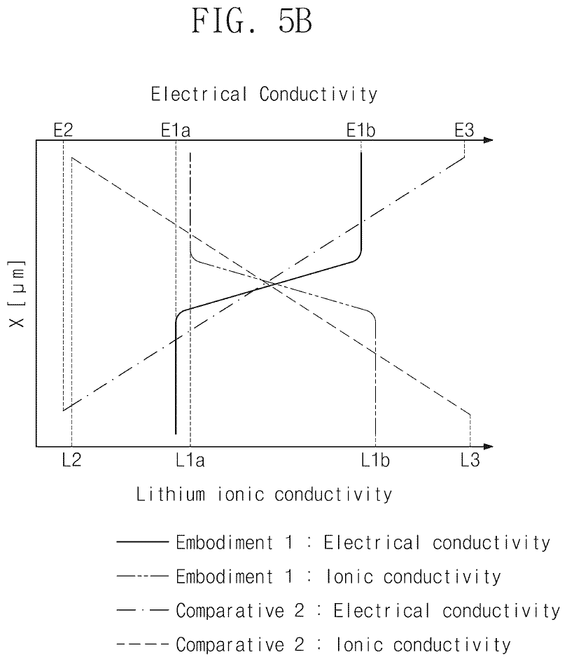

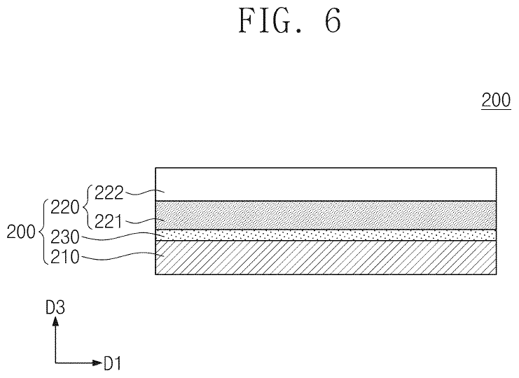

FIG. 4 is a cross-sectional view showing a negative electrode for an all-solid-state battery according to an embodiment of the present disclosure. FIGS. 5A and 5B are graphs showing electrical conductivity and ionic conductivity as a function of distance depicted in FIG. 4. FIG. 6 is a cross-sectional view showing a negative electrode for an all-solid-state battery according to an embodiment of the present disclosure. The negative electrode coating layer 220 will be discussed in more detail with reference to FIGS. 4, 5A, 5B, and 6.

The negative electrode coating layer 220 may induce growth of lithium metal between the negative electrode coating layer 220 and the negative electrode current collector 210 if (e.g., when) the all-solid-state battery 10 is charged. The negative electrode coating layer 220 may serve as a protection layer for lithium metal and concurrently (e.g., simultaneously) may suppress or reduce precipitation and growth of lithium dendrites.

The negative electrode coating layer 220 may include a first negative electrode coating layer 221 and a second negative electrode coating layer 222 on the first negative electrode coating layer 221. The negative electrode layer 200 may include the negative electrode current collector 210, the first negative electrode coating layer 221 on the negative electrode current collector 210, and the second negative electrode coating layer 222 on the first negative electrode coating layer 221. The first negative electrode coating layer 221 may be between the negative electrode current collector 210 and the second negative electrode coating layer 222. The first negative electrode coating layer 221 and the second negative electrode coating layer 222 may have materials different from each other (e.g., the first negative electrode coating layer 221 may include materials different from the second negative electrode coating layer 222).

The first negative electrode coating layer 221 may include a first metal and a first carbon. The first metal may be a lithiophilic element. The lithiophilic element may refer to a metal that exhibits high affinity with (e.g., toward) lithium. For example, the first metal may include at least one lithiophilic element selected from gold (Au), platinum (Pt), palladium (Pd), silicon (Si), silver (Ag), aluminum (AI), bismuth (Bi), tin (Sn), zinc (Zn), magnesium (Mg), and indium (In). The first negative electrode coating layer 221 may include metal oxide containing the first metal.

The first metal may have a lithium diffusion coefficient less than that of a second metal which will be further discussed below. The lithium diffusion coefficient of the first metal may be in a range from about 10⁻¹⁴ cm²/s to about 10⁻⁸ cm²/s, but the present disclosure is not limited thereto. As the first negative electrode coating layer 221 includes a lithiophilic element, the first negative electrode coating layer 221 may have lithium ionic conductivity greater than that of the second negative electrode coating layer 222.

ΔG1 may be given as Gibbs free energy between molten lithium and the first metal of the first negative electrode coating layer 221. Gibbs free energy ΔG1 between the first metal and molten lithium may be defined by Gibbs free energy represented by Equation 1.

$$Δ G 1 = Δ H {1}_{523.15 K} - T Δ S {1}_{523.15 K} \qquad Equation 1$$

For example, ΔG1 may be defined as Gibbs formation energy of a chemical reaction at 250° C. between the first metal and molten lithium.

For example, ΔG1≤0 kJ/mol. For another example, −1,500 kJ/mol<ΔG1≤0 kJ/mol. If (e.g., when) ΔG1 falls within the range above, there may occur an alloying reaction between lithium and the first metal (Li-first metal alloy). Thus, the first metal may induce deposition of lithium if (e.g., when) the all-solid-state battery 10 is charged. For example, a charge-discharge temperature of the all-solid-state battery 10 may be in a range from about 25° C. to about 90° C.

The first carbon may include at least one selected from carbon black, carbon nano-tube, acetylene black, furnace black, ketjen black, and graphene. In an embodiment, the first negative electrode coating layer 221 may include a mixture of carbon black and silver (Ag).

The first negative electrode coating layer 221 may further include an additive in addition to the first metal and the first carbon. The first negative electrode coating layer 221 may include at least one additive selected from, for example, a binder, a filler, a coating agent, a dispersant, and an ionic conductivity agent.

The second negative electrode coating layer 222 may include a second metal and a second carbon. The second metal may be a conductive element (e.g., an electrically conductive element). For example, the second metal may include at least one conductive element selected from beryllium (Be), boron (B), titanium (Ti), vanadium (V), chromium (Cr), manganese (Mn), iron (Fe), cobalt (Co), nickel (Ni), copper (Cu), zirconium (Zr), niobium (Nb), molybdenum (Mo), technetium (Tc), ruthenium (Ru), hafnium (Hf), tantalum (Ta), tungsten (W), rhenium (Re), and osmium (Os). The second negative electrode coating layer 222 may include metal oxide containing the second metal.

The second metal may have an electrical conductivity greater than that of the first metal. At a temperature of about 20° C., the electrical conductivity of the second metal may be about 1×10⁶ S/m to about 1×10⁸ S/m, but the present disclosure is not limited thereto. Thus, the second negative electrode coating layer 222 may facilitate the transport of electrons. As the second negative electrode coating layer 222 includes a conductive element (e.g., an electrically conductive element), the second negative electrode coating layer 222 may have an electrical conductivity greater than that of the first negative electrode coating layer 221.

ΔG2 may be given as Gibbs free energy between molten lithium and the second metal of the second negative electrode coating layer 222. The Gibbs free energy ΔG2 between the second metal and molten lithium may be defined by Gibbs free energy represented by Equation 2.

$$Δ G 2 = Δ H {2}_{523.15 K} - T Δ S {2}_{523.15 K} \qquad Equation 2$$

For example, ΔG2 may be defined as Gibbs formation energy of a chemical reaction at 250° C. between the second metal and molten lithium.

The second metal may be a lithiophobic element. ΔG2 may be greater than ΔG1. For example, ΔG2>0 kJ/mol. For another example, 0 kJ/mol<ΔG2<1,000 kJ/mol. If (e.g., when) ΔG2 falls within the range above, there may not occur an alloying reaction between lithium and the second metal.

The second carbon may include at least one selected from carbon black, carbon nano-tube, acetylene black, furnace black, ketjen black, and graphene. In an embodiment, the second negative electrode coating layer 222 may include a mixture of carbon black and nickel (Ni).

The second negative electrode coating layer 222 may further include an additive in addition to the second metal and the second carbon. The second negative electrode coating layer 222 may include at least one additive selected from, for example, a binder, a filler, a coating agent, a dispersant, and an ionic conductivity agent.

For example, an amount of the first metal may be less than that of the second metal. For example, the amount of the first metal may be about 3 wt % to about 50 wt % relative to the total weight of the first negative electrode coating layer 221. For example, the amount of the second metal may be about 5 wt % to about 90 wt % relative to the total weight of the second negative electrode coating layer 222.

The first negative electrode coating layer 221 may have a thickness TH3 of about 3 μm to about 8 μm. The second negative electrode coating layer 222 may have a thickness TH4 of about 3 μm to about 8 μm. A sum of the thicknesses TH3 and TH4 of the first and second negative electrode coating layers 221 and 222 may be in a range of about 5 μm to about 20 μm. For example, the sum of the thicknesses TH3 and TH4 of the first and second negative electrode coating layers 221 and 222 may be in a range of about 5 μm to about 15 μm. A ratio of the thickness TH4 of the second negative electrode coating layer 222 to the thickness TH3 of the first negative electrode coating layer 221 may be in a range of about 0.6 to about 1.4. For example, the thickness TH3 of the first negative electrode coating layer 221 may be substantially the same as the thickness TH4 of the second negative electrode coating layer 222.

If (e.g., when) each of the thicknesses TH3 and TH4 of the first and second negative electrode coating layers 221 and 222 falls within the range above, the all-solid-state batter 10 may have an increased lifespan. If (e.g., when) each of the thicknesses TH3 and TH4 of the first and second negative electrode coating layers 221 and 222 is less than the range above, no lithium may be uniformly precipitated and dendrites may be formed in the negative electrode layer 200. If (e.g., when) each of the thicknesses TH3 and TH4 of the first and second negative electrode coating layers 221 and 222 is greater than the range above, the all-solid-state battery 10 may have a reduced energy density.

The first and second negative electrode coating layers 221 and 222 may not be mixed with each other, and may be distinguished with a scanning electron microscope (SEM). A ratio of a capacity of the negative electrode layer 200 to a capacity of the positive electrode layer 100 may be in a range from about 0.1 to about 0.5. This may be because the all-solid-state battery 10 according to the present disclosure does not include a negative electrode active material, and the negative electrode layer 200 includes the first and second negative electrode coating layers 221 and 222.

Referring to FIGS. 5A and 5B, as the first negative electrode coating layer 221 includes a lithiophilic element, and as the second negative electrode coating layer 222 includes a conductive element (e.g., an electrically conductive element), there may be a reduction of difference in lithium ionic conductivity between the first negative electrode coating layer 221 and the second negative electrode coating layer 222. For example, as discussed below, a lithium ionic conductivity of Embodiment 1 according to the present disclosure may be constant as a first ionic conductivity L1 over distance X. In contrast, as discussed below, a lithium ionic conductivity of Comparative 2 may be changed as a function of distance X within a range between a second ionic conductivity L2 and a third ionic conductivity L3. The lithium ionic conductivity of Comparative 2 may increase in a direction from the second negative electrode coating layer 222 toward the first negative electrode coating layer 221.

In embodiments, the lithium ionic conductivity of Embodiment 1 may be changed as a function of distance X within a range between a minimum ionic conductivity L1a and a maximum ionic conductivity L1b. In embodiments, the first negative electrode coating layer 221 may have the maximum ionic conductivity L1b, and the second negative electrode coating layer 222 may have the minimum ionic conductivity L1a. A lithium ionic conductivity may be abruptly changed on an interface between the first negative electrode coating layer 221 and the second negative electrode coating layer 222.

There may be a reduction of difference in electrical conductivity between the first negative electrode coating layer 221 and the second negative electrode coating layer 222. For example, an electrical conductivity of Embodiment 1 according to the present disclosure may be constant as a first electrical conductivity E1 over distance X. In contrast, an electrical conductivity of Comparative 2 may be changed as a function of distance X within a range between a second electrical conductivity E2 and a third electrical conductivity E3. The electrical conductivity of Comparative 2 may increase in a direction from the first negative electrode coating layer 221 toward the second negative electrode coating layer 222.

In embodiments, as discussed below, the lithium ionic conductivity of Embodiment 1 may be changed as a function of distance X within a range between a minimum electrical conductivity Ela and a maximum electrical conductivity E1b. In embodiments, the first negative electrode coating layer 221 may have the minimum electrical conductivity Ela, and the second negative electrode coating layer 222 may have the maximum electrical conductivity E1b. An electrical conductivity may be abruptly changed on an interface between the first negative electrode coating layer 221 and the second negative electrode coating layer 222.

Referring to FIG. 6, the negative electrode layer 200 may further include a lithium deposition layer 230. The lithium deposition layer 230 may be between the negative electrode current collector 210 and the first negative electrode coating layer 221. The lithium deposition layer 230 may include lithium precipitated if (e.g., when) the all-solid-state battery 10 is charged. The lithium deposition layer 230 may be formed thin on the negative electrode current collector 210 if (e.g., when) the all-solid-state battery 10 is charged.

For example, the first negative electrode coating layer 221 and the second negative electrode coating layer 222 may be sequentially formed on the negative electrode current collector 210. The first negative electrode coating layer 221 may be formed by coating on the negative electrode current collector 210 a first coating slurry including the first metal and the first carbon that are discussed above. For example, the first negative electrode coating layer 221 may be formed by bar-coating on the negative electrode current collector 210 a first coating slurry including the first metal and the first carbon discussed above.

The second negative electrode coating layer 222 may be formed by coating on the first negative electrode coating layer 221 a second coating slurry including the second metal and the second carbon that are discussed above. In embodiments, the second coating slurry may not be mixed with the first negative electrode coating layer 221. For example, the second negative electrode coating layer 222 may be formed by bar-coating on the first negative electrode coating layer 221 a second coating slurry including the first metal and the first carbon discussed above.

According to embodiments of the present disclosure, the first and second negative electrode coating layers 221 and 222 may be sequentially formed on the negative electrode current collector 210. As the first negative electrode coating layer 221 includes a lithiophilic element, and as the second negative electrode coating layer 222 includes a conductive element (e.g., an electrically conductive element), there may be a reduction of difference in lithium ionic conductivity and electrical conductivity along a thickness direction (or the third direction D3) of the negative electrode layer 200. Thus, lithium may be uniformly (e.g., substantially uniformly) precipitated between the negative electrode current collector 210 and the first negative electrode coating layer 221, with the result that the all-solid-state battery 10 may improve in lifespan characteristics.

The present disclosure will be discussed below in more detail by way of embodiments. These embodiments, however, are provided as examples to illustrate the subject matter of the present disclosure, and the scope of the present disclosure is not limited to these embodiments.

### Embodiment 1

A negative electrode current collector 210 was provided thereon with a negative electrode layer 200 including a first negative electrode coating layer 221 and a second negative electrode coating layer 222. The first negative electrode coating layer 221 included silver (Ag) as a first metal, and an amount of silver (Si) was 15 wt % relative to the total weight of the first negative electrode coating layer 221. A thickness of the first negative electrode coating layer 221 was 5 μm. The second negative electrode coating layer 222 included iron (Fe) as a second metal, and an amount of iron was 32 wt % relative to the total weight of the second negative electrode coating layer 222. A thickness of the second negative electrode coating layer 222 was 5 μm. ΔG1 was given as Gibbs free energy between silver (Ag) as the first metal and molten lithium, and ΔG2 was given as Gibbs free energy between iron (Fe) as the second metal and molten lithium. In this embodiment, ΔG<ΔG2.

The negative electrode layer 200 was prepared using the following method.

A nickel thin layer of 10 μm in thickness was prepared as a negative electrode current collector. For the formation of the first negative electrode coating layer 221, a first metal particle, a first carbon (carbon black), a polyvinylidene fluoride (PVDF) binder (S5130 commercially available from Solvay Co.), and an N-methylpyrrolidone (NMP) solvent were mixed to prepare a first coating slurry. A bar coater was used to coat the first coating slurry was on a nickel thin layer, and the mixture was dried for 10 minutes in a convection oven at 80° C. to form a stack of the negative electrode current collector 210 and the first negative electrode coating layer 221.

For the formation of the second negative electrode coating layer 222, a second metal particle, a second carbon (carbon black), a polyvinylidene fluoride (PVDF) binder, and an N-methylpyrrolidone (NMP) solvent were mixed to prepare a second coating slurry. A bar coater was used to coat the second coating slurry on the first negative electrode coating layer 221, and then the mixture was dried for 10 minutes in a convection oven at 80° C. to form a stack of the negative electrode current collector 210, the first negative electrode coating layer 221, and the second negative electrode coating layer 222. Through the process above, the negative electrode layer 200 was prepared in which the negative electrode current collector 210, the first negative electrode coating layer 221, and the second negative electrode coating layer 222 were sequentially stacked.

### Embodiment 2

A negative electrode layer 200 was prepared according to substantially the same method as in Embodiment 1, except that the first negative electrode coating layer 221 included silver (Ag) as a first metal having an amount of 5 wt % relative to the total weight of the first negative electrode coating layer 221, a thickness of the first negative electrode coating layer 221 was 7 μm, the second negative electrode coating layer 222 included iron (Fe) as a second metal having an amount of 55 wt % relative to the total weight of the second negative electrode coating layer 222, and a thickness of the second negative electrode coating layer 222 was 5 μm.

### Embodiment 3

A negative electrode layer 200 was prepared according to substantially the same method as in Embodiment 1, except that the first negative electrode coating layer 221 included silver (Ag) as a first metal having an amount of 25 wt % relative to the total weight of the first negative electrode coating layer 221, a thickness of the first negative electrode coating layer 221 was 5 μm, the second negative electrode coating layer 222 included copper (Cu) as a second metal having an amount of 64 wt % relative to the total weight of the second negative electrode coating layer 222, and a thickness of the second negative electrode coating layer 222 was 6 μm.

### Embodiment 4

A negative electrode layer 200 was prepared according to substantially the same method as in Embodiment 1, except that the first negative electrode coating layer 221 included zinc (Zn) as a first metal having an amount of 40 wt % relative to the total weight of the first negative electrode coating layer 221, a thickness of the first negative electrode coating layer 221 was 7 μm, the second negative electrode coating layer 222 included iron (Fe) as a second metal having an amount of 62 wt % relative to the total weight of the second negative electrode coating layer 222, and a thickness of the second negative electrode coating layer 222 was 6 μm.

### Embodiment 5

A negative electrode layer 200 was prepared according to substantially the same method as in Embodiment 1, except that the first negative electrode coating layer 221 included zinc oxide (ZnO) as a first metal having an amount of 30 wt % relative to the total weight of the first negative electrode coating layer 221, a thickness of the first negative electrode coating layer 221 was 6 μm, the second negative electrode coating layer 222 included iron (Fe) as a second metal having an amount of 70 wt % relative to the total weight of the second negative electrode coating layer 222, and a thickness of the second negative electrode coating layer 222 was 4 μm.

### Embodiment 6

A negative electrode layer 200 was prepared according to substantially the same method as in Embodiment 1, except that the first negative electrode coating layer 221 included silver (Ag) as a first metal having an amount of 44 wt % relative to the total weight of the first negative electrode coating layer 221, a thickness of the first negative electrode coating layer 221 was 8 μm, the second negative electrode coating layer 222 included nickel (Ni) as a second metal having an amount of 53 wt % relative to the total weight of the second negative electrode coating layer 222, and a thickness of the second negative electrode coating layer 222 was 3 μm.

### Embodiment 7

A negative electrode layer 200 was prepared according to substantially the same method as in Embodiment 1, except that the first negative electrode coating layer 221 included zinc (Zn) as a first metal having an amount of 49 wt % relative to the total weight of the first negative electrode coating layer 221, a thickness of the first negative electrode coating layer 221 was 5 μm, the second negative electrode coating layer 222 included iron (Fe) as a second metal having an amount of 77 wt % relative to the total weight of the second negative electrode coating layer 222, and a thickness of the second negative electrode coating layer 222 was 3 μm.

### Comparative 1

A negative electrode layer 200 was prepared according to substantially the same method as in Embodiment 1, except that neither the first negative electrode coating layer 221 nor the second negative electrode coating layer 222 was formed.

### Comparative 2

A negative electrode layer 200 was prepared according to substantially the same method as in Embodiment 1, except that the first negative electrode coating layer 221 included silver (Ag) having an amount of 25 wt % relative to the total weight of the first negative electrode coating layer 221, a thickness of the first negative electrode coating layer 221 was 10 μm, and the second negative electrode coating layer 222 was not formed.

### Comparative 3

A negative electrode layer 200 was prepared according to substantially the same method as in Embodiment 1, except that the first negative electrode coating layer 221 did not include a first metal, a thickness of the first negative electrode coating layer 221 was 15 μm, an amount of iron (Fe) of the second negative electrode coating layer 222 was 50 wt % relative to the total weight of the second negative electrode coating layer 222, and a thickness of the second negative electrode coating layer 222 was 15 μm.

### Comparative 4

A negative electrode layer 200 was prepared according to substantially the same method as in Embodiment 1, except that the first negative electrode coating layer 221 included silver (Ag) having an amount of 10 wt % relative to the total weight of the first negative electrode coating layer 221, a thickness of the first negative electrode coating layer 221 was 10 μm, an amount of iron (Fe) of the second negative electrode coating layer 222 was 32 wt % relative to the total weight of the second negative electrode coating layer 222, and a thickness of the second negative electrode coating layer 222 was 20 μm.

### Comparative 5

A negative electrode layer 200 was prepared according to substantially the same method as in Embodiment 1, except that the first negative electrode coating layer 221 included silver (Ag) having an amount of 10 wt % relative to the total weight of the first negative electrode coating layer 221, a thickness of the first negative electrode coating layer 221 was 18 μm, an amount of iron (Fe) of the second negative electrode coating layer 222 was 50 wt % relative to the total weight of the second negative electrode coating layer 222, and a thickness of the second negative electrode coating layer 222 was 5.4 μm.

### Comparative 6

A negative electrode layer 200 was prepared according to substantially the same method as in Embodiment 1, except that the first negative electrode coating layer 221 included zinc (Zn) as a first metal having an amount of 40 wt % relative to the total weight of the first negative electrode coating layer 221, a thickness of the first negative electrode coating layer 221 was 7 μm, an amount of iron (Fe) of the second negative electrode coating layer 222 was 62 wt % relative to the total weight of the second negative electrode coating layer 222, and a thickness of the second negative electrode coating layer 222 was 15 μm.

### Comparative 7

A negative electrode layer 200 was prepared according to substantially the same method as in Embodiment 1, except that the first negative electrode coating layer 221 included silver (Ag) having an amount of 15 wt % relative to the total weight of the first negative electrode coating layer 221, a thickness of the first negative electrode coating layer 221 was 3 μm, an amount of iron (Fe) of the second negative electrode coating layer 222 was 32 wt % relative to the total weight of the second negative electrode coating layer 222, and a thickness of the second negative electrode coating layer 222 was 12 μm.

Table 1 shows a comparison between the negative electrodes according to the examples and the comparative examples.

TABLE 1

| | First negative electrode | | | Second negative electrode | | | |
|---|---|---|---|---|---|---|---|
| | coating layer (221) | | | coating layer (222) | | | Second |
| | | Metal | First | | Metal | Second | thickness/ |
| | First | amount | thickness | Second | amount | thickness | First |
| Category | metal | (wt %) | (μm) | metal | (wt %) | (μm) | thickness |
| Embodiment 1 | Ag | 15 | 5 | Fe | 32 | 5 | 1 |
| Embodiment 2 | Ag | 5 | 7 | Fe | 55 | 5 | 0.71 |
| Embodiment 3 | Ag | 25 | 5 | Cu | 64 | 6 | 1.2 |
| Embodiment 4 | Zn | 40 | 7 | Fe | 62 | 6 | 0.86 |
| Embodiment 5 | ZnO | 30 | 6 | Fe | 70 | 4 | 0.67 |
| Embodiment 6 | Ag | 44 | 8 | Ni | 53 | 3 | 0.38 |
| Embodiment 7 | Zn | 49 | 5 | Fe | 77 | 3 | 0.6 |
| Comparative 1 | — | 0 | 0 | — | 0 | 0 | — |
| Comparative 2 | Ag | 25 | 10 | — | 0 | 0 | — |
| Comparative 3 | — | 0 | 15 | Fe | 50 | 15 | 1 |
| Comparative 4 | Ag | 10 | 10 | Fe | 32 | 20 | 2 |
| Comparative 5 | Ag | 10 | 18 | Fe | 50 | 5.4 | 0.3 |
| Comparative 6 | Zn | 40 | 7 | Fe | 62 | 15 | 2.14 |
| Comparative 7 | Ag | 15 | 3 | Fe | 32 | 12 | 4 |

### Fabrication Example: All-Solid-State Battery

### Positive Electrode Active Material

A powder of LiNi_{0.8}Co_{0.15}Mn_{0.05}O₂ (NCM) was prepared as a positive electrode active material.

### Positive Electrode Layer

As discussed above, a powder of LiNi_{0.8}Co_{0.15}Mn_{0.05}O₂ (NCM) was prepared as a positive electrode active material. A crystalline argyrodite-type solid electrolyte (Li₆PS₅Cl) was prepared as a solid electrolyte. Polytetrafluoroethylene (PTFE, TEFLON™ commercially available from Dupont Inc.) was prepared as a binder. Carbon nano-fiber (CNF) was prepared as a conductive material. The positive electrode active material, the solid electrolyte, the conductive material, and the binder were mixed in a weight ratio of 84.2:11.5:2.9:1.4, and the mixture was formed into a positive electrode sheet. The positive electrode sheet was pressed on a positive electrode current collector formed of carbon-coated aluminum foil of 18 μm in thickness to manufacture a positive electrode layer. A positive electrode active material layer included in the positive electrode layer had a thickness of about 100 μm.

### Negative Electrode Layer

The aforementioned negative electrode was prepared.

### Solid Electrolyte Layer

An argyrodite-type solid electrolyte, Li₆PS₅Cl, was added to an isobutylyl isobutylate binder solution containing an acrylate-based polymer to prepare a solid electrolyte solution (solid content: 50 wt %, mixing ratio of solid electrolyte to binder: 98.7:1.3).

The solid electrolyte solution was coated on a release polytetrafluoroethylene film, and dried at 60° C. for 2 hours to manufacture a solid electrolyte layer of 100 μm in thickness.

### Fabrication of All-Solid-State Battery

The negative electrode layer, the solid electrolyte layer, and the positive electrode layer were sequentially stacked. The prepared stack was subject to plate pressing at 25° C. for 10 minutes under a pressure of 100 MPa to fabricate an all-solid-state battery.

### Experimental Example 1: Lifespan of All-Solid-State Battery

Lifespan evaluation was performed on the all-solid-state batteries fabricated using the negative electrode layers of Embodiments 1 to 7 and Comparatives 1 to 7. The lifespan evaluation was conducted by repeating 100 charge-discharge cycles with a constant current of 0.33 C. For example, the lifespan evaluation was repeatedly performed in such a way that the all-solid-state battery was charged with a constant current of 0.33 C until a voltage reached 4.25 V, charged with a constant voltage (CV) of 4.25 V until a current reached 0.1 C, and then discharged with a current of 0.33 C until a voltage reached 2.5 V. The lifespan (charge-discharge efficiency) was calculated according to Equation 3. Lifespan characteristics were evaluated as A, B, and C based on the calculated result. The lifespan evaluation result is listed in Table 2.

$$Lifespan = ( {100}^{t h} discharge capacity / initial discharge capacity ) \times 100 \qquad Equation 3$$

A: Lifespan is equal to or greater than 85%
B: Lifespan is equal to or greater than 75% and less than 85%
C: Lifespan is less than 75%

TABLE 2

| Category | Lifespan evaluation (%) |
|---|---|
| Embodiment 1 | A |
| Embodiment 2 | A |
| Embodiment 3 | A |
| Embodiment 4 | A |
| Embodiment 5 | A |
| Embodiment 6 | A |
| Embodiment 7 | A |
| Comparative 1 | C |
| Comparative 2 | B |
| Comparative 3 | C |
| Comparative 4 | C |
| Comparative 5 | B |
| Comparative 6 | C |
| Comparative 7 | B |

Referring to Table 2, the lifespan characteristics of the all-solid-state batteries according to Embodiments 1 to 7 are superior to those of the all-solid-state batteries according to Comparatives 1 to 7. Therefore, it may be ascertained that the lifespan of the all-solid-state battery can be extended depending on the thicknesses of the first and second negative electrode coating layers 221 and 222.

For example, if (e.g., when) the negative electrode coating layer 220 is omitted, or if (e.g., when) the first negative electrode coating layer 221 is formed alone without forming the second negative electrode coating layer 222, the all-solid-state batteries exhibit reduced lifespan characteristics compared to the all-solid-state battery according to Embodiments 1 to 7.

Referring to Embodiments 1 to 7 and Comparatives 4 to 7, It may be observed that the lifespan of the all-solid-state battery can be extended if (e.g., when) the thickness of each of the first and second negative electrode coating layers 221 and 222 falls within a range of 3 μm to 8 μm. It may be ascertained that the lifespan characteristics of the all-solid-state battery can be improved if (e.g., when) a ratio of the thickness of the second negative electrode coating layer 222 to the thickness of the first negative electrode coating layer 221 falls within a range of 0.6 to 1.4.

According to embodiments of the present disclosure, first and second negative electrode coating layers may be sequentially on (e.g., formed on) a negative electrode current collector. As the first negative electrode coating layer includes a lithiophilic element, and as the second negative electrode coating layer includes a conductive element (e.g., an electrically conductive element), it may be possible to reduce a difference in lithium ionic conductivity and electrical conductivity depending on a thickness direction of a negative electrode layer. Thus, lithium may be uniformly (e.g., substantially uniformly) precipitated between the negative electrode current collector and the first negative electrode coating layer, with the result that an all-solid-state battery may improve in lifespan characteristics. An all-solid-state battery according to embodiments of the present disclosure may have excellent lifespan characteristics.

Although some embodiments of the present disclosure have been discussed with reference to the accompanying drawings, it will be understood that various suitable changes in form and details may be made therein without departing from the spirit and scope of the present disclosure. It therefore will be understood that the embodiments described above are just illustrative but not limitative in all aspects.

What is claimed is:

1. A negative electrode for an all-solid-state battery, the negative electrode comprising:
a negative electrode current collector;
a first negative electrode coating layer on the negative electrode current collector, wherein the first negative electrode coating layer comprises a first metal and a first carbon; and
a second negative electrode coating layer on the first negative electrode coating layer, wherein the second negative electrode coating layer comprises a second metal and a second carbon,
wherein ΔG1 is given as Gibbs free energy of a chemical reaction at 250° C. between the first metal and molten lithium,
wherein ΔG2 is given as Gibbs free energy of a chemical reaction at 250° C. between the second metal and molten lithium,
wherein ΔG1<ΔG2, and
wherein a ratio of a thickness of the second negative electrode coating layer to a thickness of the first negative electrode coating layer is in a range of about 0.6 to about 1.4.

2. The negative electrode as claimed in claim 1, wherein:
$$Δ G 1 \leq 0 kJ / mol , and$$
$$Δ G 2 > 0 kJ / mol .$$

3. The negative electrode as claimed in claim 1, wherein:
−1,500 kJ/mol<ΔG1≤0 kJ/mol, and
0 kJ/mol<ΔG2<1,000 kJ/mol.

4. The negative electrode as claimed in claim 1, wherein:
the thickness of the first negative electrode coating layer is in a range of about 3 μm to about 8 μm, and
the thickness of the second negative electrode coating layer is in a range of about 3 μm to about 8 μm.

5. The negative electrode as claimed in claim 1, wherein a sum of the thickness of the first negative electrode coating layer and the thickness of the second negative electrode coating layer is in a range of about 5 μm to about 15 μm.

6. The negative electrode as claimed in claim 1, wherein, at a temperature of about 20° C., an electrical conductivity of the second metal is about 1×10⁶ S/m to about 1×10⁸ S/m.

7. The negative electrode as claimed in claim 1, wherein a lithium diffusion coefficient of the first metal is less than a lithium diffusion coefficient of the second metal,
wherein the lithium diffusion coefficient of the first metal is in a range of about 10⁻¹⁴ cm²/s to about 10⁻⁸ cm²/s.

8. The negative electrode as claimed in claim 1, wherein the first metal comprises at least one lithiophilic element selected from gold (Au), platinum (Pt), palladium (Pd), silicon (Si), silver (Ag), aluminum (Al), bismuth (Bi), tin (Sn), zinc (Zn), magnesium (Mg), and indium (In).

9. The negative electrode as claimed in claim 1, wherein the second metal comprises at least one conductive element selected from beryllium (Be), boron (B), titanium (Ti), vanadium (V), chromium (Cr), manganese (Mn), iron (Fe), cobalt (Co), nickel (Ni), copper (Cu), zirconium (Zr), niobium (Nb), molybdenum (Mo), technetium (Tc), ruthenium (Ru), hafnium (Hf), tantalum (Ta), tungsten (W), rhenium (Re), and osmium (Os).

10. The negative electrode as claimed in claim 1, wherein:
an amount of the first metal is about 3 wt % to about 50 wt % relative to a total weight of the first negative electrode coating layer,
an amount of the second metal is about 5 wt % to about 90 wt % relative to a total weight of the second negative electrode coating layer, and
the amount of the first metal is less than the amount of the second metal.

11. The negative electrode as claimed in claim 1, further comprising a lithium deposition layer between the negative electrode current collector and the first negative electrode coating layer.

12. The negative electrode as claimed in claim 1, wherein:
the first carbon comprises at least one selected from carbon black, carbon nano-tube, acetylene black, furnace black, ketjen black, and graphene, and
the second carbon comprises at least one selected from carbon black, carbon nano-tube, acetylene black, furnace black, ketjen black, and graphene.

13. The negative electrode as claimed in claim 1, wherein:
an ionic conductivity of the first negative electrode coating layer is the same as or greater than an ionic conductivity of the second negative electrode coating layer, and
an electrical conductivity of the second negative electrode coating layer is the same as or greater than an electrical conductivity of the first negative electrode coating layer.

14. The negative electrode as claimed in claim 1, wherein an electrical conductivity of the second metal is greater than an electrical conductivity of the first metal.

15. An all-solid-state battery, comprising:
a positive electrode layer;
a negative electrode layer; and
a solid electrolyte layer between the positive electrode layer and the negative electrode layer,
wherein the negative electrode layer comprises:
a negative electrode current collector;
a first negative electrode coating layer on the negative electrode current collector, wherein the first negative electrode coating layer comprises a first metal and a first carbon; and
a second negative electrode coating layer on the first negative electrode coating layer, wherein the second negative electrode coating layer comprises a second metal and a second carbon,
wherein an ionic conductivity of the first negative electrode coating layer is greater than an ionic conductivity of the second negative electrode coating layer, and
wherein an electrical conductivity of the second negative electrode coating layer is greater than an electrical conductivity of the first negative electrode coating layer, and
wherein a sum of a thickness of the first negative electrode coating layer and a thickness of the second negative electrode coating layer is in a range of about 5 μm to about 15 μm.

16. The all-solid-state battery as claimed in claim 15, wherein:
ΔG1 is given as Gibbs free energy of a chemical reaction at 250° C. between the first metal and molten lithium,
ΔG2 is given as Gibbs free energy of a chemical reaction at 250° C. between the second metal and molten lithium,
$$Δ G 1 \leq 0 kJ / mol , and$$
$$Δ G 2 > 0 kJ / mol .$$

17. The all-solid-state battery as claimed in claim 15, wherein:
$$- 1 , 500 kJ / mol < Δ G 1 \leq 0 kJ / mol$$
$$0 kJ / mol < Δ G 2 < 1 , 000 kJ / mol .$$

18. The all-solid-state battery as claimed in claim 15, wherein:
an amount of the first metal is about 3 wt % to about 50 wt % relative to a total weight of the first negative electrode coating layer,
an amount of the second metal is about 5 wt % to about 90 wt % relative to a total weight of the second negative electrode coating layer, and
the amount of the first metal is less than the amount of the second metal.

19. The all-solid-state battery as claimed in claim 15, wherein a ratio of a capacity of the negative electrode layer to a capacity of a positive electrode layer is in a range of about 0.1 to about 0.5.

20. An all-solid-state battery, comprising:
a positive electrode layer;
a negative electrode layer; and
a solid electrolyte layer between the positive electrode layer and the negative electrode layer,
wherein the negative electrode layer comprises:
a negative electrode current collector;
a first negative electrode coating layer on the negative electrode current collector, wherein the first negative electrode coating layer comprises a first metal and a first carbon; and
a second negative electrode coating layer on the first negative electrode coating layer, wherein the second negative electrode coating layer comprises a second metal and a second carbon,
wherein ΔG1 is given as Gibbs free energy of a chemical reaction at 250° C. between the first metal and molten lithium,
wherein ΔG2 is given as Gibbs free energy of a chemical reaction at 250° C. between the second metal and molten lithium,
wherein ΔG1<ΔG2, and
wherein a ratio of a thickness of the second negative electrode coating layer to a thickness of the first negative electrode coating layer is in a range of about 0.6 to about 1.4.
